(19) United States
(12) Patent Application Publication
(10) Pub. No.: US 2016/0102484 A1
(43) Pub. Date: Apr. 14, 2016

(54) ASSISTED MOVEMENT DEVICE FOR A DOOR OF A VEHICLE

(71) Applicant: MANITOU ITALIA S.R.L., Castelfranco Emilia (Mo) (IT)

(72) Inventor: MARCO IOTTI, REGGIO EMILIA (IT)

(21) Appl. No.: 14/813,385

(22) Filed: Jul. 30, 2015

(30) Foreign Application Priority Data
Oct. 9, 2014 (IT) MO2014A000283

(51) Int. Cl. E05B 85/12; E05B 79/22; E05B 85/24

(52) U.S. Cl. CPC E05B 85/12; E05B 85/243; E05B 79/22

(57) ABSTRACT

An assisted movement device for a door (P) of a vehicle, comprises: a door lock (2) for dosing the door (P), suitable for changing from a locked configuration to an unlocked configuration; activation means (7) suitable for enabling the door lock (2) to pass from the locked configuration to the unlocked configuration thereof; a control latch (3) and a bolt (4) operationally connected for engaging the lock (2) in the locked configuration.

The activation means (7) comprises at least one activating element for activating rotation of the control latch (3), so as to pass from the locked configuration to the unlocked configuration of the door lock (2).

The device (1) further includes remote control means (8) for activating the activating element.

The invention has for an object an assisted movement device for a door of a vehicle.

The invention finds application within the industry of telescopic lifts, handlers or similar work machines.

In the following description, particular reference will be made, by way of example, to vehicles provided with a door arranged at an impracticable height from the ground, which is typical of large-sized work machines, nonetheless, the invention will not be affected in its general principles due to this.

Thus, the vehicles to which reference is made in the present description, are those supplied with the operator's access door to the driver's cab, being arranged at such a distance from the ground, that the operator can reach the cab only by climbing a ladder.

In fact, the difference in level between the ground and the inner floor surface of the driver's cab is such as to require an aid for the operator to get on and off the vehicle.

The operator who is preparing to climb the ladder must first of all open the door to enter the cab of the vehicle.

For safety reasons, the door is provided with a lock enabling locking and unlocking thereof.

If the door is locked, the operator must first of all proceed to a prior unlocking thereof. This operation generally occurs by use of a key and by pushing a button.

A door handle is generally provided next to the door lock, where a locking cylinder and/or button is usually arranged as well. The handle assumes the function of a gripping element in order to enable the operator to open the door by gripping it.

However, door handles are often located at heights which are difficult to be reached.

In order to open the door, the operator thus climbs a ladder the vehicle is supplied with, and after unlocking of the door lock, he/she grabs and then pulls the handle.

Such a door opening mode may result difficult and particularly dangerous.

The operator shall remain suspended on the ladder, leaning back only at the time the door is being opened. During the step wherein the operator is suspended on the ladder and is operating on the handle to unlock and/or open the door lock, he/she comes to be in such an uncomfortable position, to the point of running the risk of losing a grip thus slipping and falling to the ground.

Additionally, owing to the fact that work vehicles often operate in environments exposed to atmospheric agents and commonly characterized by the presence of mud, dirt and sand, if the ladder steps are not clean and dry, the operator runs the risk to slip and fall to the ground.

The Applicant has therefore observed several drawbacks in the prior art which are encountered on a daily basis when using vehicles provided with doors that are characterized by a very low degree in terms of use simplicity, safety and practicability because unfavorably positioned relative to the ground; on the other hand, such an unfavorable positioning is attributable to constructional requirements of vehicles.

In this context, the technical task at the base of the present invention is to provide an assisted movement device which overcomes the drawbacks of the prior art.

Particularly, it is an object of the present invention to provide an assisted movement device for the door of a vehicle being able to simplify door opening operations, thereby providing a sufficiently suitable solution in terms of automation level, aimed at facilitating door unlocking and opening operations thus enabling the operator to have an easy, quick and safe access inside the vehicle cab.

A further object of the present invention is to provide a vehicle door being simple from a structural viewpoint, and so configured as to be openable in a simple, quick and safe manner.

The technical task mentioned and the aims specified are substantially attained by an assisted movement device for a door of a vehicle, realized according to claim 1.

Further characteristics and advantages of the present invention will become more apparent from the indicative, and therefore non-limiting description of a preferred but non-exclusive embodiment of an assisted movement device for a door of a vehicle, as illustrated in the accompanying drawings wherein:

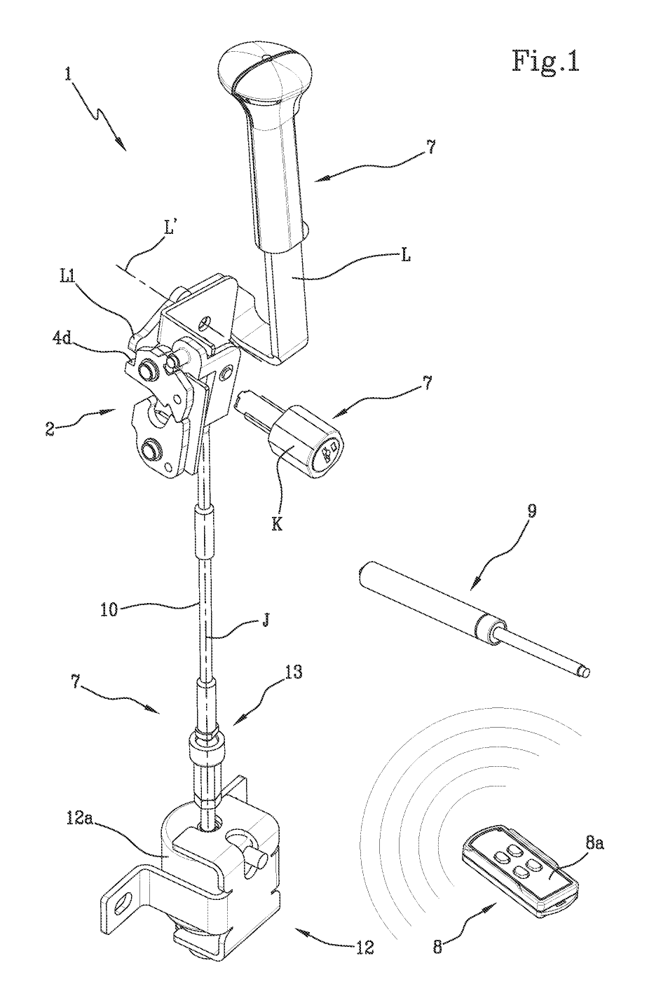

FIG. 1 is a schematic axonometric view of an assisted movement device for a door of a vehicle;

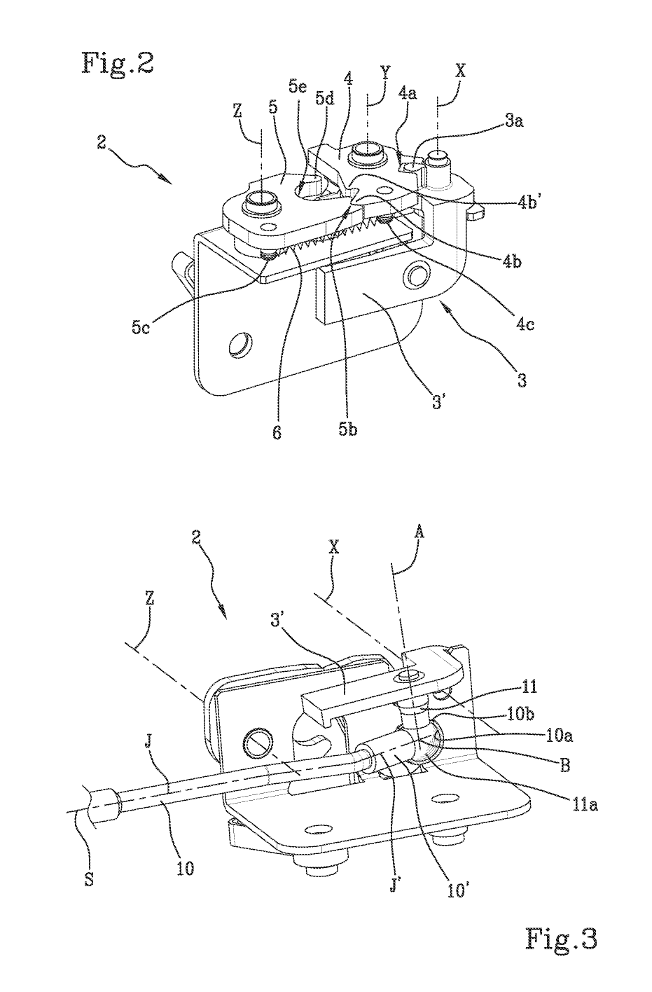

FIG. 2 is a schematic axonometric view of the door lock of FIG. 1;

FIG. 3 is a schematic axonometric view of a portion of FIG. 1 according to a different perspective;

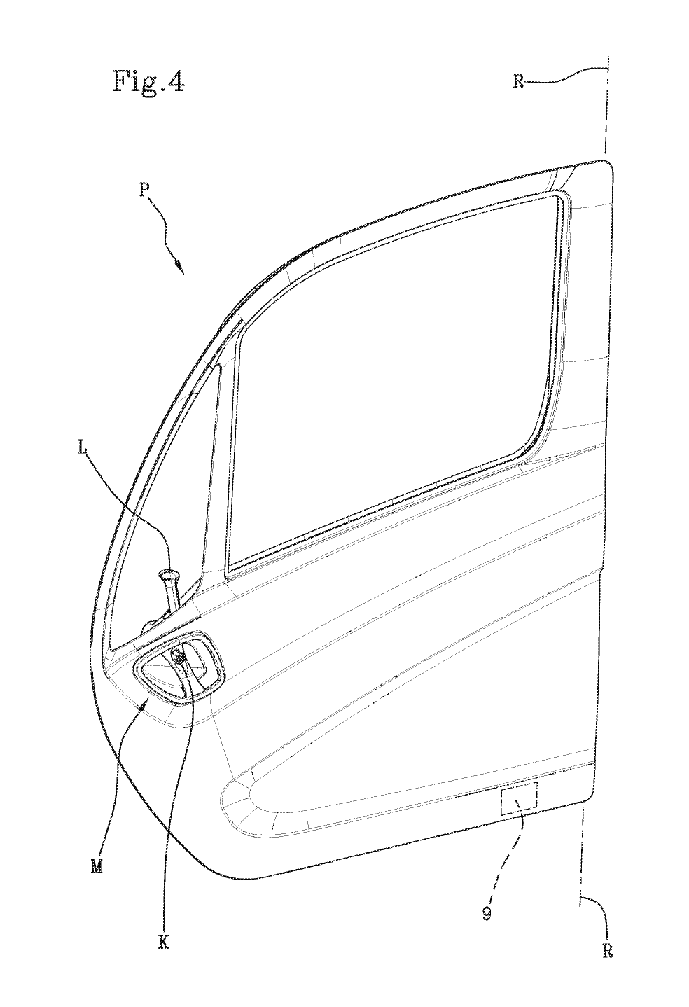

FIG. 4 is a schematic axonometric view of a door for a vehicle according to the present invention; and

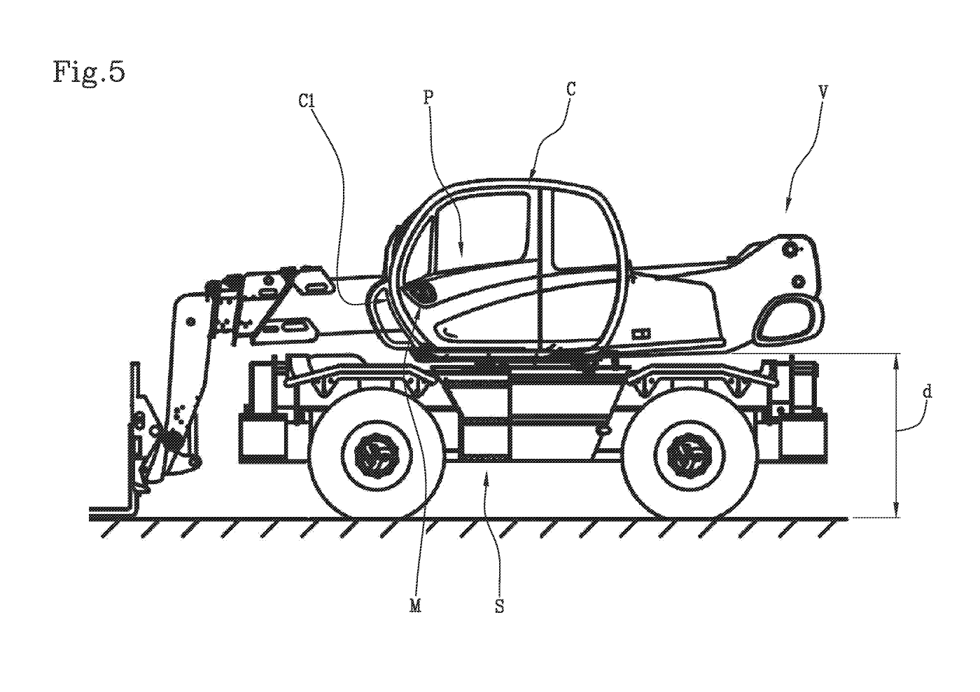

FIG. 5 is a schematic side view of a vehicle with door arranged at an impracticable height from the ground according to the present invention.

With reference to the attached figures, by 1, it is generally indicated an assisted movement device for a door of a vehicle in its entirety.

FIG. 4 illustrates a possible embodiment of a door P of a vehicle V. Preferably the door P is hinged to the vehicle V via fixing systems of the known type so as to rotate about an axis of rotation R, thereby enabling opening of the door P and allowing access to the cab of the vehicle V by an operator.

In FIG. 5 there is shown a possible embodiment of a vehicle V with a door P arranged at a height “d” which is not accessible from the ground. By a height “d”, it is particularly meant the difference in height between the ground and the lower edge of the door P; the height “d” must be climbed over by the operator which is then able to enter the cab with the aid of one or more steps S of the vehicle V, located below the door, so as to facilitate the operator's ascent and descent.

The door P shall be provided with a lock 2 in order for it to be moved. To open and close the door P, the operator must indeed first of all lock or unlock the door lock 2.

The device 1 thus comprises a door lock 2, suitable for passing from a locked configuration, wherein the door lock 2 is engaged with a section C1 of a frame C of a vehicle V, to an unlocked configuration of the door lock 2, wherein the door lock 2 is disengaged from the section C1 of the frame C, and the door P is movable between a close position and an open position thereof.

With reference to FIG. 2, the door lock 2 preferably comprises a control latch 3, a bolt 4 and a locking member 5 operationally connected one to another, so as to engage the door lock 2 with the section C1 of the frame C when the door P is in the locked configuration thereof.

Preferably, the control latch 3 is adapted to rotate about an axis of rotation X and comprises a connection element 3a configured for rotating internally of a trigger seat 4a of the bolt 4, which trigger seat 4a is suitable for receiving it.

Preferably, the bolt 4 is configured for rotating about an axis of rotation Y parallel to the axis of rotation X, and comprises a lift-jack 4b which is able to rotate internally of an unlocking seat 5b of the locking member 5. The locking member 5 is configured for rotating about an axis of rotation Z parallel to the axis of rotation X and exhibits a cavity 5e suitable for receiving an engagement portion which is solidly constraint with the section C1 of the frame C, not illustrated in the appended figures.

The bolt 4 and the locking member 5 are connected elastically with a spring 6, which is configured for maintaining the former in the locked condition of the door.

Preferably, the spring 6 is fixed at the ends thereof to a coupling pin 4c, passing the bolt 4 along an axis of rotation parallel to the axis of rotation X, and to a coupling pin 5c, passing the locking member along an axis of rotation parallel to the axis of rotation Y.

When the door lock 2 is in the locked configuration thereof, the spring 6 is stretched, whereas when the door lock 2 is in the unlocked configuration, the biasing force of the spring 6 causes the two pins 4c, 5c to come closer to one another and the spring 6 assumes a rest configuration.

The bolt 5 comprises a ratchet 4b′ adjacent to the lift-jack 4b and adapted to be snap-inserted into the unlocking seat 5b of the locking member 5 in an unlocked configuration of the door lock 2, following rotation of the locking member 5 about the axis of rotation Z, and/or rotation of the bolt 4 about the axis of rotation Y, and/or rotation of the control latch 3 about the axis of rotation X.

The locking member 5 comprises a portion of encumbrance 5d suitable for preventing the unlocking portion 5e of the section C1 from coming out of the cavity 5e in the locked configuration. In other words, the engagement portion is trapped between the cavity 5e of the locking member 5 and the bolt 4.

Following rotation of the locking member 5 about the axis of rotation Z, and/or of the bolt 4 about the axis of rotation Y, and/or of the control latch 3 about the axis of rotation X, when the vehicle door P is closed, the door lock 2 passes from the locked configuration to the unlocked configuration thereof; this happens when the portion of encumbrance 5d, by rotating about the axis of rotation Z as a result of an external intervention which activates rotation, assumes a non-operative position, wherein a free opening of the door P is possible.

The door P is therefore movable from the close position to the open position thereof.

When passing from the close position to the open position, the door P rotates about the axis of rotation R, thus the engagement portion of the section C1 of the frame C is pulled out from the door lock 2, which thus moves away from said section C1.

The device 1 comprises activation means 7 configured for allowing the door lock 2 to pass from the locked configuration to the unlocked configuration thereof. In other words, the external intervention previously mentioned, which activates rotation of the control latch 3, the bolt 4, and the control member 5, (for the sake of description from now on herein referred to simply as “internal mechanism of the door lock 2”), is represented by the activation means 7.

The activation means 7 comprises at least one activating element configured to activate rotation of the internal mechanism of the door lock 2, so as to pass from the locked configuration to the unlocked configuration of the door lock 2, wherein the activating element is controlled by remote control means 8.

In this way, the operator can advantageously act at a distance to unlock the door lock 2 of the door P, prior to climbing the steps and open the door P to enter the cab of the vehicle V.

With reference to FIG. 1, according to a possible embodiment of the present invention, the remote control means 8 preferably comprises a remote control device 8a, for example a wireless remote control. The device 1 further comprises thrust means 9 of the door P operationally associated to the remote control means 8 and configured for moving the door P from the close position in the the unlocked configuration of the door lock 2, to the open position of the door P.

Thanks to the present invention, the operator can comfortably open the door P from the ground, by simply acting on the remote control device 8a, which is preferably a pocket-size remote control device.

Preferably the remote control means 8 activate the thrust means 9 of the door P once the activating element has terminated the activating step of the internal mechanism rotation of the door P and the encumbrance portion 5d is in the non-operating configuration.

Advantageously the operator, who is on the ground, can open the door P by simply acting on the remote control device 8a, which remote control device 8a, by sending a signal, shah provide to command activation of the activating element, which in turn activates unlocking of the door lock 2, followed by activation of the thrust means 9, via which the door P can be opened automatically.

In this way, having opened the door P from the ground, the operator can have an easy and comfortable access to the cab of the vehicle V by simply climbing the steps 3, without having to open the door P by hand.

Preferably the thrust means 9 comprises a gas spring.

With reference to FIGS. 1-3, preferably the activating element is a control lever 10 which is operationally connected with the control latch 3, thereby setting it into rotation about the axis of rotation X, so that changing from the locked configuration to the unlocked configuration of the door lock 2 is enabled.

Preferably, the control lever 10 is associated with the control latch 3 via a ball joint arranged between a pin 11 and said control lever. In particular, the control lever is provided with a spherical cavity 10a, suitable for receiving the pin 11 with a spherical end 11a, so that the spherical end 11a of the pin 11 is able to rotate within the spherical cavity 10a of the control lever 10, and the spherical cavity 10a is able to rotate about the spherical end 11a.

Preferably the pin 11 is inserted within an anchoring profile 3′ of the control latch 3, such that the pin 11 is arranged along an axis A, thus being solidly constraint with the movement of the control latch 3.

Preferably, the control lever 10 is connected to movement means 12 which move it along a main sliding direction 3, preferably coinciding with a main development direction J of the control lever 10.

Referring to the embodiment illustrated in FIG. 3, the control lever 10 exhibits a portion 10′ relative to the spherical end 10a of the control lever 10, with a secondary development direction J′ passing through the center B of the spherical end 11a of the pin 11, whereby the secondary development direction J′ and the main development direction J are incident but not parallel to one another.

The operator, via the remote control means 8, activates the movement means 12 of the control lever 10, which control means 8 enable to the control lever 10 to slide along the direction J, thereby causing the spherical end 10a of the control lever 10 to rotate about the spherical end 11a of the pin 11, being the angle decreased by the value comprised between the secondary development direction J′ of the control lever 10 and the axis A of the pin 11. This occurs until the pin 11 comes into contact with a spherical section profile 10b of the spherical end 10a and the control latch 3 is thus set into rotation about the axis of rotation X in order to activate the internal mechanism of the door lock 2.

The movement means 12 of the control lever 10 preferably comprises an electromagnet 12a, as illustrated in FIG. 1, however said movement means may also comprise any device able to move the control lever 10 along the main sliding direction S.

Preferably, the control lever 10 comprises a compensation joint 13, configured to compensate any small misalignments of the control lever 10 that may occur during the movement.

In the embodiment of the present invention, as illustrated in the appended figures, the door P preferably comprises a handle M, whereon the operator can act to lock, unlock and move the door P manually.

In particular, the assisted movement device 1 preferably comprises further activating elements to lock and unlock the door lock 2 and open the door P as an alternative to the control lever 10.

In FIG. 1 there are illustrated further activating elements by way of example which can be activated manually by the operator:

a manual control lever L able to set the bolt 4 into rotation about the axis Y as a result of the engagement of a tooth L1 of the manual control lever L with a tooth 4d of the bolt 4. The lever L can be grasped by an operator from inside the cabin and then rotated about an axis of rotation L′ of the lever L;

a cylinder K able to receive a key from outside of the door P at the handle M and to set the control latch 3 into rotation about the axis of rotation X.

A modification kit for the door P of the vehicle V may be further provided in the event the user wishes to change the current configuration of the assisted movement device on a pre-existing door P comprising by way of example, a small cylinder K and/or a lever L, so as to provide it with an assisted movement device 1 according to the present invention. In this way, thanks to the installation of a modification kit comprising a control lever 10, movement means 12 and a pin 11, the current manual activation means 7 of the door P can be advantageously improved, wherein passage of the door lock 2 from the locked configuration to the unlocked configuration thereof and opening of the door P, become automatic.

Absent an hole for the tightening of the pin 11 located on the control latch 3, this can be obtained for example by applying a fastener, preferably a breakstem fastener.

The control lever 10 can be realized in such a way, as to be able to pass inside the door P within the space available, without the need for any mechanical modifications on the door lock 2 and on the door P as far as possible.

According to a possible aspect of the present invention, in order to close and lock the door P, it is possible to act in a reversible manner via the remote control means 8. In such a case, the remote control means 8 provide first of all to control the thrust means 9 of the door P, so as to move it from the open to the close position; subsequently said control means 8 provide to command the activation means 7 such as to cause passing of the door lock 2 from the unlocked configuration to the locked configuration thereof.

The present invention thus attains the proposed aim, wherein the drawbacks of the prior art are overcome owing to a solution which improves the operator's safety conditions when vehicles supplied with a door P are being used, whose door is located at an impracticable height from the ground; unlocking and opening operations of the door P thus become simple and immediate.

1. An assisted movement device for a door (P) of a vehicle, comprising:
a door lock (2) for closing the door (P) and that is suitable for passing from a locked configuration, wherein it is engaged with a section (C1) of a frame (C) of a vehicle (V), to an unlocked configuration, wherein the lock (2) is disengaged from said section (C1) of the frame (C);
activation means (7) suitable for enabling passage of the door lock (2) from the locked configuration to the unlocked configuration thereof;
wherein the door lock (2) comprises a control latch (3) and a bolt (4) that are operationally connected so as to engage the door lock (2) with said section (C1) in the locked configuration; the device (1) being characterized in that said activation means (7) comprises at least one activating element for activating the rotation of the control latch (3) so as to pass from the locked configuration to the unlocked configuration of the door lock (2), the device (1) including remote control means (8) for activating the activating element.

2. The assisted movement device for a door of a vehicle according to claim 1, wherein said control latch (3) and said bolt (4) are configured to lock a connection element for connecting said section (C1) of the frame (C) when the door lock (2) is in the locked configuration and to release said connection element when the door lock (2) is in the unlocked configuration thereof; and wherein said activating element comprises a control lever (10) that is operationally connected with said control latch (3) so as to set it into rotation about an axis of rotation (X), so as to pass from the locked configuration to the unlocked configuration of the door lock (2).

3. The assisted movement device for a door of a vehicle according to claim 2, wherein said control lever (10) is provided with a spherical cavity (10a) suitable for receiving a pin (11) with a spherical end (11a) so that the spherical end (11a) of said pin (11) is suitable for rotating in the spherical cavity (10a) of the control lever (10) and that said spherical cavity (10a) is suitable for rotating about the spherical end (11a), said pin (11) being inserted inside an anchoring section (3′) of the control latch (3) so that it moves integrally with the control latch (3).

4. The assisted movement device for a door of a vehicle according to claim 2, wherein said control lever (10) is connected to movement means (12) for moving said control lever (10) so as to move said control lever (10) along a main sliding direction (S).

5. The assisted movement device for a door of a vehicle according to claim 4, wherein said movement means (12) can be activated by said remote control means (8).

6. The assisted movement device for a door of a vehicle according to claim 4, wherein said movement means (12) for moving said control lever (10) comprises an electromagnet (12a).

7. The assisted movement device for a door of a vehicle according to claim 2, wherein said control lever (10) comprises a compensation joint (13).

8. The assisted movement device for a door of a vehicle according to claim 1, wherein said remote control means (8) comprises a remote control device (8a), for example a wireless remote control.

9. A door for a vehicle comprising: a door lock suitable for passing from a locked configuration, wherein said lock (2) is engaged with a section (C1) of a frame (C) of a vehicle (V), to an unlocked configuration of the door lock (2), wherein the door lock (2) is disengaged from said section (C1); and a movement device (1) according to claim 1.

10. The door for a vehicle, according to claim 9, comprising thrust means (9) configured to move the door (P) automatically from the close position in the unlocked configuration of the door lock (2) to the open position of the door (P).
